(19) United States
(12) Patent Application Publication
(10) Pub. No.: US 2005/0235631 A1
(43) Pub. Date: Oct. 27, 2005

(54) Sensor element for a sensor for determining the oxygen concentration in the exhaust gas of internal combustion engines

(76) Inventor: Bernd Schumann, Rutesheim (DE)

Correspondence Address: KENYON & KENYON, ONE BROADWAY, NEW YORK, NY, 10004, US

(21) Appl. No.: 10/517,171

(22) PCT Filed: May 21, 2003
(86) PCT No.: PCT/DE03/01639

§ 371 Date: Jun. 28, 2005

(30) Foreign Application Priority Data
Jun. 18, 2002 (DE) 102 27 012.0

(51) Int. Cl. F01N 3/00; B01D 53/34; G01N 27/26

(52) U.S. Cl. 60/276; 204/426; 422/177

(57) ABSTRACT

A sensor element for a sensor for determining the oxygen concentration in the exhaust gas of internal combustion engines, e.g., for a broadband lambda sensor, is provided. The sensor element has a solid electrolyte forming a pump cell together with an inner electrode inside a cavity, and an outer electrode exposed to the exhaust gas on the outside. The sensor element also includes a prechamber formed in the solid electrolyte, and a diffusion channel formed in the solid electrolyte, the diffusion channel connecting the prechamber and the cavity, and being filled with a diffusion barrier. To prevent measuring inaccuracies of the sensor in the presence of very high quantities of hydrocarbons in the exhaust gas, a catalytic converter for the oxidation of hydrocarbons is located in the prechamber, the catalytic converter being configured as an electrochemical catalytic converter having two electrodes electrically connected with one another.

### FIELD OF THE INVENTION

The present invention is directed to a sensor element for a sensor for determining the oxygen concentration in the exhaust gas of internal combustion engines, in particular for a broadband lambda sensor.

### BACKGROUND INFORMATION

In a conventional sensor element for a lambda sensor for determining the lambda-value as a measure of the oxygen concentration in the exhaust gas of the internal combustion engine (described, e.g., in published German patent document DE 198 57 471), the cavity accommodating the inner electrode of the pump cell, the diffusion chamber along with the diffusion barrier, and the prechamber are configured in a circle around a hole drilled into the ion-conducting solid electrolyte, preferably made of zirconium oxide (ZrO₂), so that the prechamber has a cylindrical access opening for the exhaust gas, and the diffusion channel has a cylindrical intake opening from the direction of the prechamber and a cylindrical exit opening toward the cavity. The prechamber, here, has only a small radial depth, at least big enough so that the drill making the hole in the solid electrolyte does not touch the inner cylinder wall of the diffusion barrier during the drilling process clogging the pores of the diffusion barrier, which could result in a change in the diffusion resistance of the diffusion barrier.

In the case of large proportions of unburned or partially burned hydrocarbons in the exhaust gas such as develop during fuel post-injection for soot filter regeneration in diesel engines, the measuring accuracy of the sensor is negatively affected by the different diffusion coefficients of hydrocarbons and oxygen as they pass through the diffusion barrier. Depending on the type of hydrocarbons, they have molecules of varying sizes and therefore diffusion coefficients which are larger or smaller than or equal to that of oxygen. High molecular weight hydrocarbons such as decane permeate the diffusion barrier at a much lower rate than oxygen, so that—per time unit—significantly less hydrocarbon passes through the diffusion barrier and enters the cavity. In the cavity of the pump cell, less oxygen is consumed after the reaction of the hydrocarbons with oxygen than would be expected stoichiometrically given the concentration of the gas fractions in the exhaust gas. The sensor, in other words, measures too high of an oxygen concentration. Conversely, low molecular weight hydrocarbons such as methane permeate the diffusion barrier at a higher rate than oxygen. More hydrocarbons therefore enter the cavity and react with more oxygen than would be expected given their concentration in the exhaust gas. The sensor therefore measures too low of an oxygen concentration.

### SUMMARY OF THE INVENTION

The sensor element according to the present invention has the advantage that the catalytic converter upstream of the diffusion barrier causes the hydrocarbons to oxidize more efficiently. The exhaust gas volume entering the cavity through the diffusion barrier thus does not contain any unburned hydrocarbons having diffusion coefficients deviating from the diffusion coefficient of the oxygen, so that the stoichiometric ratio of the oxygen is set upstream from the diffusion barrier and is not changed again in the exhaust gas volume present in the cavity; in other words, the sensor delivers correct lambda values.

According to an example embodiment of the present invention, the catalytic converter is operated as an electrochemical catalytic converter in the prechamber, for which purpose spatially distanced and electrically connected electrodes made of an electrically conductive material essentially containing a precious metal such a platinum, rhodium, palladium and/or an alloy thereof, are placed on two opposing chamber walls, and where the electrode material may have an oxidation-promoting oxide such as aluminum oxide or cerium oxide added to it.

According to alternative example embodiments of the present invention, the electrochemical catalytic converter may be connected—either permanently or for a limited time such as only during fuel post-injection—to a DC voltage, or the electrical conductivity of the prechamber electrodes may be used simply for the purpose of having the electrodes function as a catalytic converter. In the former case, the prechamber electrodes are operated such that oxygen is electrochemically pumped into the prechamber, where the oxygen efficiently oxidizes the hydrocarbons. For this purpose, an anodic current is applied to the prechamber electrodes, for which purpose the prechamber electrodes are connected to a DC voltage having a higher potential than that of the outer electrodes of the pump cell. In the latter case of forming, a cathodic current is applied to the prechamber electrodes, with the prechamber electrodes being subjected to a lower potential than that of the outer electrodes of the pump cell. This cathodic current flows for a few minutes at a voltage higher than the decomposition voltage of the solid electrolyte material, resulting in the electrochemical formation—on the surface of the prechamber electrodes—of a cermet from the electrode metal and the zirconium oxide of the solid electrolyte, imparting to the prechamber electrodes a very good catalytic activity. Here, the sensor element is preferably subjected to a temperature between 800° C. and 1200° C.

Forming of the catalytic converter takes place according to the sintering process of the sensor element and may remain restricted to a one-time forming. In this case, it is not necessary to run a connecting cable from the sensor element to the prechamber electrodes, since these prechamber electrodes may be contacted through the access opening in the prechamber in the case of a one-time forming. It is also possible, however, to carry out the forming of the catalytic converter in the prechamber repeatedly from time to time, even while the sensor is being used. In this case, a connecting cable leading to the prechamber electrodes must be provided and connected to the control unit of the sensor.

### BRIEF DESCRIPTION OF THE DRAWING

FIG. 1 is a schematic representation of a cross section of a sensor element for a sensor configured as a broadband lambda sensor according to an example embodiment of the present invention.

### DETAILED DESCRIPTION

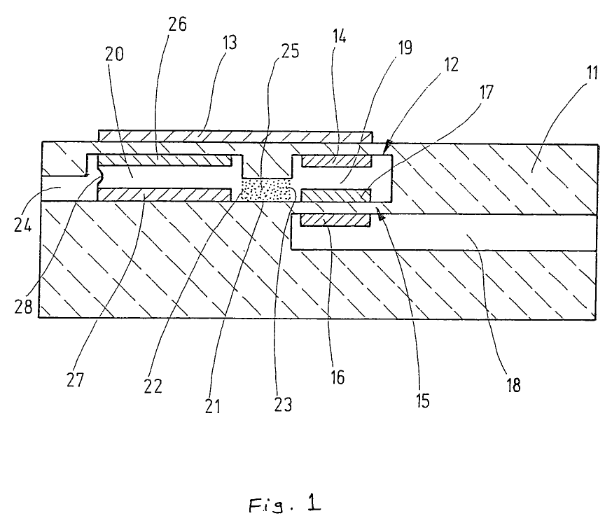

The sensor element for a sensor configured as a broadband lambda sensor for determining the oxygen concentration in the exhaust gas, schematically shown in FIG. 1, has solid electrolyte 11 forming the sensor body, where solid electrolyte 11 is made of yttrium-stabilized zirconium oxide, for instance, and is usually composed of several ceramic layers joined by a sintering process. The individual ceramic layers are not shown here.

Solid electrolyte 11 contains a pump cell 12 which operates on the limit current principle, and has outer electrode 13 and inner electrode 14, as well as a measuring cell or Nernst cell 15 having a reference electrode 16 and a Nernst electrode or measuring electrode 17. Reference electrode 16 is located in a reference channel 18 formed in solid electrolyte 11, with a reference gas, preferably air, admitted to reference channel 18. Alternatively, it is also possible to generate the reference gas atmosphere electrochemically, in which case reference channel 18 is replaced by a barely gas-permeable layer. Solid electrolyte 11, furthermore, contains cavity 19, prechamber 20 upstream from cavity 19, and diffusion channel 21 connecting prechamber 20 with cavity 19, diffusion channel 21 having an intake opening 22 toward prechamber 20, and an exit opening 23 toward cavity 19. Prechamber 20 has an access opening 24, through which exhaust gas may enter prechamber 20. Diffusion channel 21 is filled with diffusion barrier 25, made of aluminum oxide (Al₂O₃) or zirconium oxide (ZrO₂), for instance, and has a given diffusion resistance. The barrier material may also have catalytically active material added to it. Measuring electrode 17 of Nernst cell 15, and inner electrode 14 of pump cell 12 are installed spatially-distanced in cavity 19. Measuring electrode 17 and inner electrode 14 may be connected electrically and mechanically. The geometric layout of cavity 19 and reference channel 18 is designed such that reference electrode 16 and measuring electrode 17 of Nernst cell 15, and inner electrode 14 and outer electrode 13 of pump cell 12 are separated from each other by solid electrolyte 11. Outer electrode 13 is situated on the surface of solid electrolyte 11 and is exposed to the exhaust gas when the sensor is in use. Access opening 24 of prechamber 20 is configured such that the access cross section of prechamber 20 for the exhaust gas is much larger than the access cross section of diffusion barrier 25, and at least large enough so that the access cross section of prechamber 20 only slightly increases the diffusion resistance of diffusion barrier 25 for the exhaust gas. Normally, a resistance heater, mounted on a support, is additionally connected to solid electrolyte 11 to heat the sensor element to the required operating temperature. This resistance heater is not shown here.

As discussed previously, a high fraction of unburned or partially-burned hydrocarbons in the exhaust gas impairs the measuring accuracy of the sensor element, resulting in measuring errors in the lambda value. To prevent this measuring error, a catalytic converter for the oxidation of hydrocarbons is located in prechamber 20. This catalytic converter may be a purely chemical catalytic converter, with prechamber 20 filled with a packing of an oxidation-promoting catalyst material. Zirconium oxide (ZrO₂), platinum (Pt), rhodium (Rh) and palladium (Pd) are suitable catalyst materials.

In this example embodiment of the sensor element, the catalytic converter is operated as an electrochemical catalytic converter, with two electrodes 26 and 27 made of an electrically conducting material, installed on two opposing walls of prechamber 20. The chamber walls supporting electrodes 26, 27 are aligned parallel to each other and extend parallel to the center axes of access opening 24 and intake opening 22 which, in turn, are aligned with each other. The electrode material may be a precious metal such as platinum, rhodium, palladium and/or an alloy thereof, and where an oxidation-promoting oxide such as zirconium oxide (ZrO₂), zeolite, aluminum oxide (Al₂O₃) or cerium oxide (Ce₂O₃) may be added to improve the catalytic effect. The two electrodes 26, 27 are connected with one another in an electrically conductive manner, symbolized in the drawing by connecting wire 28. During operation of the sensor, electrodes 26, 27 are connected to a DC potential which is higher than that of outer electrode 13 of pump cell 12. This causes oxygen ions to be electrochemically pumped from solid electrolyte 11 into prechamber 20, efficiently oxidizing the hydrocarbons contained in the exhaust gas volume entering prechamber 20. No unburned hydrocarbons penetrate diffusion barrier 25, and the stoichiometric ratio of the oxygen concentration in cavity 19 is not distorted. Application of DC voltage may be permanent or occur only during those operational phases of the internal combustion engine, where a particularly high proportion of unburned or partially burned hydrocarbons is generated such as during fuel post-injection for soot filter regeneration or for heating the exhaust gas catalytic converter.

During electrical operation of the electrochemical catalytic converter, part of the oxygen electrically pumped into prechamber 20 exits back into the exhaust gas via access opening 24. This fraction, however, is numerically determinable through measurements in gas test benches, and is taken into consideration when calculating the actual oxygen content in the exhaust gas from the current signal of pump cell 12.

In an alternative embodiment of the sensor element, the electrochemical catalytic converter in prechamber 20 is not operated electrically; instead, the electrical conductivity of electrodes 26, 27 is used to form electrodes 26, 27 as catalytic converters, since electrodes 26, 27 are generally produced by cofiring and have poor catalytic activity because of the high sintering temperatures to which the sensor element is exposed during manufacture. For the purpose of forming the catalytic converter, electrodes 26, 27 are connected for several minutes to a voltage above that of the decomposition voltage of the zirconium oxide of solid electrolyte 11 such as 1.3 V-2 V relative to reference air, so that a cathodic current flows through electrodes 26, 27 and the sensor element is exposed to a temperature between 800 EC and 1200 EC. During this process, a cermet forms electrochemically on the surface of electrodes 26, 27 from the electrode material and the zirconium oxide, which exhibits high catalytic activity. This forming process may be carried out only once after sintering of the sensor element, or it may be performed repeatedly when the sensor is in use. In the latter case, a connecting wire leading to electrodes 26, 27 must be run out of the sensor element.

The present invention is not limited to the above-described sensor element for a broadband lambda sensor having pump cell 12 and Nernst cell 15. The sensor element may also be used as a sensor configured as a linear air/fuel sensor, in which case Nernst cell 15 along with its reference electrode 16 and measuring electrode 17, as well as reference channel 18 are not needed. This sensor element, only containing pump cell 12, also operates on the limit current principle.

Furthermore, it is possible to additionally fill the space between electrodes 26, 27 in prechamber 20 with a catalytically active material. The material used for this purpose may again be ZrO₂, Pt, Rh, Pd—as in the case of the chemical catalytic converter in prechamber 20 described above.

Although the invention has been described in detail including the example embodiments thereof, such description is for illustrative purposes only, and it is to be understood that changes and variations including improvements may be made by those skilled in the art without departing from the spirit or scope of the following claims.

1-15. (canceled)

16. A sensor element for a sensor for determining an oxygen concentration in an exhaust gas of an internal combustion engine, the sensor element comprising:
a solid electrolyte having a cavity formed inside;
an inner electrode located in the cavity;
an outer electrode located on the outside of the solid electrolyte and exposed to the exhaust gas, the outer electrode forming a pump cell together with the solid electrolyte and the inner electrode;
a prechamber formed inside the solid electrolyte, the prechamber having an access opening for the exhaust gas;
a diffusion channel formed inside the solid electrolyte, the diffusion channel comprising an intake opening toward the prechamber and an exit opening toward the cavity, the diffusion channel being filled with a diffusion barrier; and
a catalytic converter located in the prechamber.

17. The sensor element of claim 16, wherein the catalytic converter is a chemical catalytic converter.

18. The sensor element of claim 17, further comprising a packing made of an oxidation-promoting catalyst material, the packing substantially filling the prechamber.

19. The sensor element of claim 16, wherein the catalytic converter is an electrochemical catalytic converter.

20. The sensor element of claim 19, wherein the catalytic converter includes two electrodes made of a precious metal, each electrode being supported by a wall of the prechamber such that the two electrodes are supported on opposing walls of the prechamber, the electrodes being electrically connected to one another.

21. The sensor element of claim 20, wherein the electrodes of the catalytic converter further include an oxidation-promoting oxide.

22. The sensor element of claim 20, wherein the walls of the prechamber supporting the electrodes of the catalytic converter are substantially parallel to a center axis of the access opening of the prechamber and to a center axis of the intake opening of the diffusion channel.

23. The sensor element of claim 22, wherein the center axis of the access opening of the prechamber and the center axis of the intake opening of the diffusion channel are aligned with each other.

24. The sensor element of claim 16, wherein a cross section of the prechamber is substantially larger than a cross section of the diffusion barrier.

25. The sensor element of claim 20, wherein the electrodes of the catalytic converter are configured to be one of permanently and intermittently connected to a selected DC potential during the operation of the sensor, the selected DC potential being higher than a potential of the outer electrode.

26. The sensor element of claim 20, wherein the electrodes of the catalytic converter further include a cermet, the cermet coating the surfaces of the electrodes of the catalytic converter, the cermet being formed by an electrochemical forming process from the electrode material and the material of the solid electrolyte.

27. A method for forming electrodes of a catalytic converter in a sensor element for a sensor for determining an oxygen concentration in an exhaust gas of an internal combustion engine, the sensor element including a solid electrolyte having a cavity formed inside; an inner electrode located in the cavity; an outer electrode located on the outside of the solid electrolyte and exposed to the exhaust gas, the outer electrode forming a pump cell together with the solid electrolyte and the inner electrode; a prechamber formed inside the solid electrolyte, the prechamber having an access opening for the exhaust gas; a diffusion channel formed inside the solid electrolyte, the diffusion channel comprising an intake opening toward the prechamber and an exit opening toward the cavity, the diffusion channel being filled with a diffusion barrier; the catalytic converter being located in the prechamber, the catalytic converter being an electrochemical catalytic converter, the catalytic converter including two electrodes made of a precious metal, each electrode being supported by a wall of the prechamber such that the two electrodes are supported on opposing walls of the prechamber, the electrodes being electrically connected to one another, the method comprising:
applying a selected DC voltage to the electrodes of the catalytic converter and to the outer electrode, the DC voltage having a higher potential at the outer electrode.

28. The method of claim 27, wherein the DC voltage is higher than a decomposition voltage of the material of the solid electrolyte.

29. The method of claim 27, further comprising:
heating the solid electrolyte to a temperature of between 800° C. and 1200° C.

30. The method of claim 27, wherein the duration of the application of the DC voltage to the electrodes of the catalytic converter is at least one minute.

31. The method of claim 27, further comprising:
repeating the application of the DC voltage to the electrodes of the catalytic converter while the sensor is in use.
